(19) United States
(12) Patent Application Publication
(10) Pub. No.: US 2008/0095457 A1
(43) Pub. Date: Apr. 24, 2008

(54) Image vibration detection methods and systems

(75) Inventors: Jing-Shun Lin, Yilan County (TW); Chao-Lien Tsai, Taipei City (TW)

Correspondence Address: QUINTERO LAW OFFICE, PC, 2210 MAIN STREET, SUITE 200, SANTA MONICA, CA, 90405, US

(73) Assignees: QISDA CORPORATION, TAOYUAN COUNTY (TW); BENQ CORPORATION, TAIPEI (TW)

(21) Appl. No.: 11/868,601

(22) Filed: Oct. 8, 2007

(30) Foreign Application Priority Data
Oct. 24, 2006 (TW) TW95139141

(51) Int. Cl. G06K 9/40

(52) U.S. Cl. 382/255

(57) ABSTRACT

Image vibration detection methods and systems for use in a digital camera. First, a photographing process is performed to sense images. At least one first window value of a first sensed image corresponding to an absolute region is calculated, and at least one second window value of a second sensed image corresponding to the absolute region is calculated. A first focus offset is determined according to the at least one first window value and the at least one second window value. It is determined whether the first focus offset exceeds a threshold. If so, a prompt message representing an image vibration occurred during the photographing process is displayed.

### BACKGROUND OF THE INVENTION

1. Field of the Invention

The invention relates generally to image vibration detection methods and systems, and, more particularly, to methods and systems detecting image vibration during a photographing process in digital cameras.

2. Description of the Related Art

Digital cameras with image sensors such as charge coupled device (CCD) or complementary metal oxide semiconductor (CMOS) have gradually replaced conventional film cameras. Digital cameras have become commonplace, due to ease of review and processing of captured images in related devices such as computers.

Generally, digital cameras need a longer exposure time for image capture in a darker environment. During the exposure time, captured images may suffer from undesirable vibration due to unstable camera motion. Thus, indication of vibration is displayed in the monitor prompting appropriate measures during the capture.

In conventional digital cameras, if exposure time exceeds 1 divided by a focal length (second), vibration is considered to occur, and the vibration warning is directly displayed in the monitor, irrespective of the actual stability of the camera misrepresenting the specific condition.

### BRIEF SUMMARY OF THE INVENTION

Image vibration detection methods and systems are provided.

In an embodiment of an image vibration detection method for use in a digital camera, a photographing process is performed to sense images. At least one first window value of a first sensed image corresponding to an absolute region is calculated, and at least one second window value of a second sensed image corresponding to the absolute region is calculated. A first focus offset is determined according to the at least one first window value and the at least one second window value. It is determined whether the first focus offset exceeds a first threshold. If so, a prompt message representing an image vibration occurred during the photographing process is displayed.

An embodiment of an image vibration detection system comprises an image sensor and a processing unit. The image sensor senses images during a photographing process. The processing unit calculates at least one first window value of a first sensed image corresponding to an absolute region, and at least one second window value of a second sensed image corresponding to the absolute region. The processing unit determines a first focus offset according to the at least one first window value and the at least one second window value, and determines whether the first focus offset exceeds a first threshold. If so, the processing unit displays a prompt message representing an image vibration occurred during the photographing process.

Image vibration detection methods and systems may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an image vibration detection system;

FIG. 2 is a flowchart of an embodiment of a method of focus detection;

FIG. 3A is a schematic diagram illustrating an embodiment of an absolute region;

FIG. 3B is a schematic diagram illustrating an embodiment of blocks in the absolute region;

FIG. 4A is an example of a horizontal matrix;

FIG. 4B is an example of a vertical matrix;

FIG. 5 is a flowchart of an embodiment of operation of a focus offset calculation unit;

FIG. 6A is an example of a curve of focus offset with time;

FIG. 6B is an example of a curve of focus accumulation offset with time; and

FIG. 7 is a flowchart of an embodiment of operations of an analysis unit.

### DETAILED DESCRIPTION OF THE INVENTION

Image vibration detection methods and systems are provided.

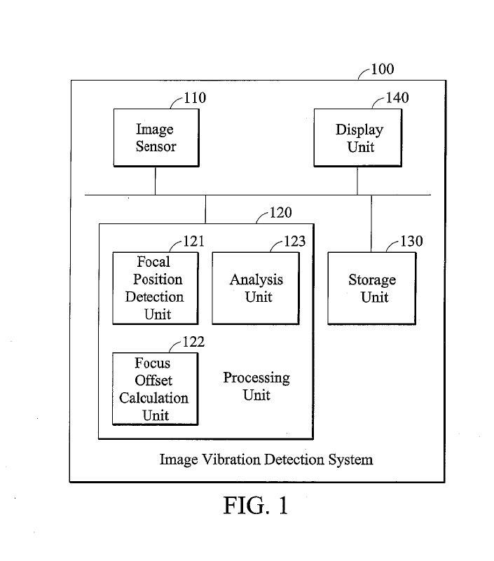

FIG. 1 illustrates an embodiment of an image vibration detection system.

The image vibration detection system 100 may be a digital camera, comprising an image sensor 110, a processing unit 120, a storage unit 130 and a display unit 140. The image sensor 110 may be a CCD (Charge Coupled Device) or CMOS (Complementary Metal Oxide Semiconductor), continuously sensing images during an exposure time of a photographing process. The processing unit 120 comprises a focal position detection unit 121, a focus offset calculation unit 122, and an analysis unit 123. The focal position detection unit 121 detects focal positions of images sensed by the image sensor 110, and transmits the focal positions to the focus offset calculation unit 122. The focus offset calculation unit 122 calculates a focus offset at any time point according to the focal positions transmitted from the focal position detection unit 121 to obtain a curve of focus offset with time. The analysis unit 123 determines whether a vibration occurs in the photographing process according to the curve of focus offset with time. The processing unit 120 performs the vibration detection of the invention, and related details are discussed later. The storage unit 130 may be a built-in memory or external memory card of the digital camera. The display unit 140 may be a LCD (Liquid Crystal Display) monitor of the digital camera or a display device separate from the digital camera, displaying images or related operating interfaces required for the vibration detection of the invention.

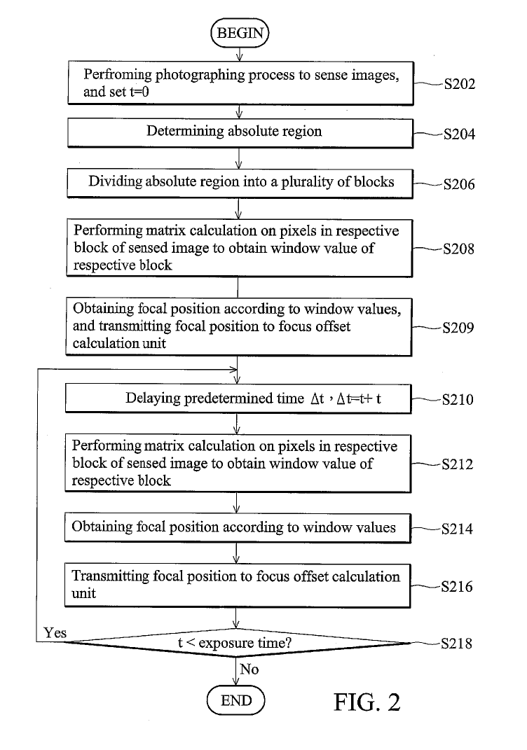

FIG. 2 shows an embodiment of a method of focus detection.

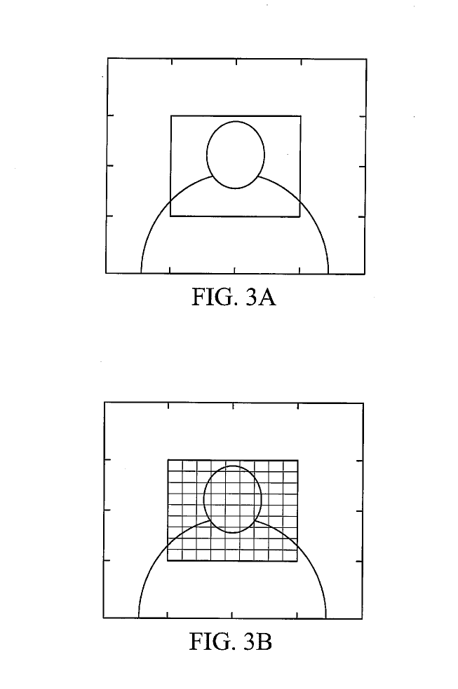

In step S202, a digital camera performs a photographing process, such that the image sensor 110 begins to sense images, and sets t=0. It is understood that the image sensor 110 continuously senses images until the termination of an exposure time of the photographing process. In step S204, an absolute region of a sensed image is determined, where a focus is sought therefor, and in step S206, the absolute region is divided into n Xn blocks. In some embodiments, the absolute region is a rectangular region at the center of the image, and the length and width thereof is half of the sensed image, as shown in FIG. 3A. Additionally, the absolute region can be divided into 9×9 blocks, as shown in FIG. 3B. It is understood that, in some embodiments, n may be an odd number, determined according to system calculation loading and the number of reference samples. If n is large, the system must spend much time in related calculation. If n is small, the reference samples may be insufficient, resulting in erroneous judgment of focus.

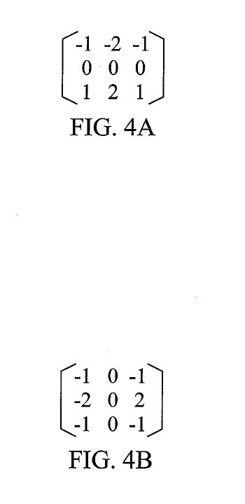

In step S208, respective pixels in respective blocks of the current sensed image are performed with matrix calculation to obtain a respective sub-window value. Thereafter, the sub-window values of respective blocks are added to obtain a window value. It is noted that each respective block in the image has a window value, representing the definition for the block image. In some embodiments, the matrix calculation multiplies a m×m horizontal matrix and a m×m vertical matrix to respective pixels in the block. The horizontal matrix and the vertical matrix may be 3×3 matrices, as shown in FIGS. 4A and 4B, respectively. After the matrix calculation, respective pixel values are added to obtain the window value of the block. It is understood that the matrices are used to calculate the edge strength in the image, that is to calculate horizontal and vertical differences between the central point and adjacent points. To obtain the differences between the central point and adjacent points, m must be an odd number. In some embodiments, m is 3 for system calculation consideration. In step S209, the focal position of the image is obtained according to the window values of respective blocks, and the focal position is transmitted to the focus offset calculation unit 122, where the block having largest window value is determined as the focal position.

In step S210, a predetermined time Δt is delayed, and Δt is added to t. It is understood that the image sensor 110 still senses images during the interval. In step S212, respective pixels in respective blocks of the current sensed image are performed with matrix calculation to obtain a respective sub-window value. Thereafter, the sub-window values of respective blocks are added to obtain a window value. In step S214, the focal position of the image is obtained according to the window values of respective blocks, and in step S216, the focal position is transmitted to the focus offset calculation unit 122.

Thereafter, in step S218, it is determined whether t is less than the exposure time. If so (Yes in step S218), the procedure returns to step S210. The digital camera continues image sensing, window value calculation, and focal position determination. If not (No in step S218), representing the photographing is complete, the procedure finishes. It is understood that if the photographing process finishes, the processing unit 120 generates a final image according to the images sensed by the image sensor 110.

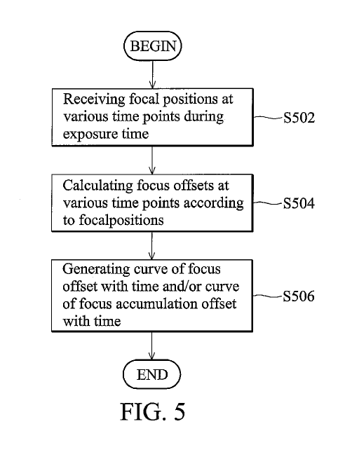

FIG. 5 shows an embodiment of operation of a focus offset calculation unit.

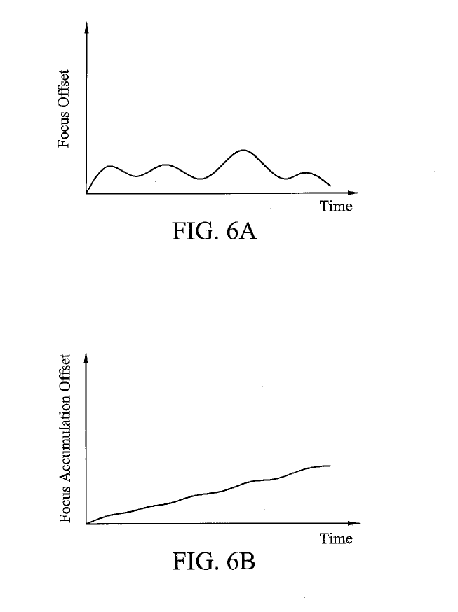

In step S502, the focus offset calculation unit 122 receives focal positions at various time points from the focal position detection unit 121, and in step S504, calculates focus offsets at various time points accordingly. In step S506, a curve of the focus offset with time or/and a curve of the focus accumulation offset with time is generated, as shown in FIGS. 6A and 6B, respectively.

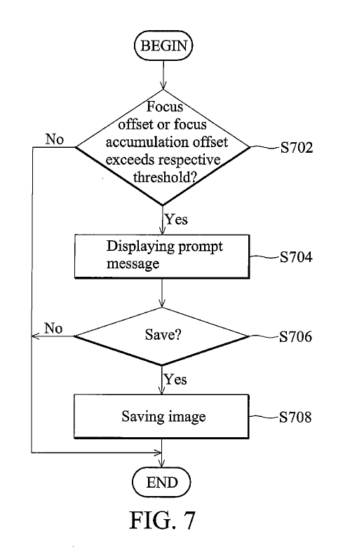

FIG. 7 shows an embodiment of operations of an analysis unit. It is understood that, in this embodiment, a vibration can be determined according to the focus offset (the distance between a specific focal position at any time point and an original focal position) during a photographing process, or/and the focus accumulation offset (the accumulation of focus offsets among respective focal positions) during a photographing process.

In step S702, it is determined whether the focus offset or the focus accumulation offset exceeds a respective threshold. The threshold corresponding to the focus offset is the maximum tolerance for the focal position, and the threshold corresponding to the focus accumulation offset is the maximum tolerance for the accumulation of focus offset among respective focal positions of sensed images. If the focus offset or the focus accumulation offset exceeds the corresponding threshold (Yes in step S702), in step S704, a vibration warning such as a prompt message representing an image vibration occurred during the photographing process is displayed in the display unit 140. It is noted that, in some embodiments, the image obtained in the photographing process is displayed in the display unit 140. Thereafter, in step S706, an interface is provided for determining whether to save the image. If so (Yes in step S706), in step S708, the image is saved to the storage unit 130. It is understood that, in some embodiments, if the focus offset and the focus accumulation offset do not exceed corresponding thresholds, the image obtained in the photographing process is also displayed in the display unit 140, and an interface is also provided for determining whether to save the image.

Image vibration detection methods and systems, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in the technology can still make various alterations and modifications without departing from the scope and spirit of this invention. Therefore, the scope of the present invention shall be defined and protected by the following claims and their equivalents.

What is claimed is:

1. An image vibration detection method for use in a digital camera, comprising:
performing a photographing process to sense images;
calculating a first window value of a first sensed image corresponding to an absolute region;
calculating a second window value of a second sensed image corresponding to the absolute region;
determining a first focus offset according to the first window value and the second window value;
determining whether the first focus offset exceeds a first threshold; and
if so, displaying a prompt message representing an image vibration occurred during the photographing process.

2. The method of claim 1 further comprising:
calculating a third window value of a third sensed image corresponding to the absolute region; and
determining a second focus offset according to the second window value and the third window value.

3. The method of claim 2 further comprising:
determining whether the sum of the first focus offset and the second focus offset exceeds a second threshold; and
if so, displaying a prompt message representing an image vibration occurred during the photographing process.

4. The method of claim 1 wherein the absolute region is a rectangular region at the center of the first sensed image and the second sensed image, and the length and width thereof is half of the first sensed image.

5. The method of claim 1 wherein the calculation of the first window value comprises:
dividing the absolute region into a plurality of blocks;
multiplying at least one matrix to respective pixels in respective blocks of the first sensed image to obtain a first sub-window value for respective pixel;
adding the first sub-window values of respective pixels in respective blocks to obtain window values of respective blocks; and
determining the first window value corresponding to a maximum window value among the window values of the respective blocks.

6. The method of claim 5 wherein the number of the blocks is n×n, and the matrix is a m×m matrix, where n and m are odd numbers.

7. The method of claim 5 wherein the calculation of the second window value comprises:
dividing the absolute region into a plurality of blocks;
multiplying at least one matrix to respective pixels in respective blocks of the second sensed image to obtain a second sub-window value for respective pixel;
adding the second sub-window values of respective pixels in respective blocks to obtain window values of respective blocks; and
determining the second window value corresponding to a maximum window value among the window values of the respective blocks.

8. The method of claim 5 wherein the determination of the first focus offset comprises:
determining a first focal position and a second focal position according to the first window value and the second window value corresponding to the blocks, respectively; and
calculating the first focus offset according to the first focal position and the second focal position, where the first focus offset is the distance between the first focal position and the second focal position.

9. The method of claim 8 wherein the first focal position and the second focal position are one of the blocks in the first sensed image and the second sensed image, respectively.

10. The method of claim 1 wherein the second sensed image is sensed a predetermined interval after the first sensed image.

11. An image vibration detection system, comprising:
an image sensor sensing images during a photographing process; and
a processing unit calculating a first window value of a first sensed image corresponding to an absolute region, calculating a second window value of a second sensed image corresponding to the absolute region, determining a first focus offset according to the first window value and the second window value, determining whether the first focus offset exceeds a first threshold, and if so, displaying a prompt message representing an image vibration occurred during the photographing process.

12. The system of claim 11 wherein the processing unit further calculates a third window value of a third sensed image corresponding to the absolute region, and determines a second focus offset according to the second window value and the third window value.

13. The system of claim 12 wherein the processing unit further determines whether the sum of the first focus offset and the second focus offset exceeds a second threshold, and if so, displays a prompt message representing an image vibration occurred during the photographing process.

14. The system of claim 11 wherein the absolute region is a rectangular region at the center of the first sensed image and the second sensed image, and the length and width thereof is half of the first sensed image.

15. The system of claim 11 wherein the processing unit calculates the first window value and the second window value by dividing the absolute region into a plurality of blocks, multiplying at least one matrix to respective pixels in respective blocks of the first sensed image and the second sensed image to obtain a first sub-window value and a second sub-window value for respective pixel, adding the first sub-window values and the second sub-window values of respective pixels in respective blocks to obtain window values of respective blocks, and determining the first window value and the second window value corresponding to a maximum window value among the window values of the respective blocks.

16. The system of claim 15 wherein the number of the blocks is n×n, and the matrix is a m×m matrix, where n and m are odd numbers.

17. The system of claim 15 wherein the processing unit determines the first focus offset by determining a first focal position and a second focal position according to the first window value and the second window value corresponding to the blocks, respectively, and calculating the first focus offset according to the first focal position and the second focal position, where the first focus offset is the distance between the first focal position and the second focal position.

18. The system of claim 17 wherein the first focal position and the second focal position are one of the blocks in the first sensed image and the second sensed image, respectively.

19. The system of claim 11 wherein the second sensed image is sensed a predetermined interval after the first sensed image.

20. The system of claim 11 wherein the processing unit further generates an image according to the first sensed image and the second sensed image after an exposure time, and provides an interface for determining whether to save the image.
